(19) United States
(12) Patent Application Publication
(10) Pub. No.: US 2024/0126089 A1
(43) Pub. Date: Apr. 18, 2024

(54) REFLECTIVE FACET WAVEGUIDE WITH DUAL REFLECTIVE FACET CONFIGURATION

(71) Applicant: GOOGLE LLC, Mountain View, CA (US)

(72) Inventors: Daniel Adema, Kitchener (CA); Timothy Paul Bodiya, Toronto (CA)

(21) Appl. No.: 18/484,835

(22) Filed: Oct. 11, 2023

Related U.S. Application Data
(60) Provisional application No. 63/416,073, filed on Oct. 14, 2022.

(51) Int. Cl. G02B 27/01

(52) U.S. Cl. CPC G02B 27/0172

(57) ABSTRACT

A waveguide includes an outcoupler with a dual reflective facet configuration. The dual reflective facet configuration includes a first set of reflective facets to receive light from a first direction and reflect the light incident thereon to an outcoupling direction. The dual reflective facet configuration also includes a second set of reflective facets to receive light from a second direction and reflect the light incident thereon to the outcoupling direction.

### CROSS-REFERENCE TO RELATED APPLICATIONS

The present application claims priority to U.S. Provisional Application No. 63/416,073, entitled “WAVEGUIDE WITH DUAL REFLECTIVE FACET CONFIGURATION” and filed on Oct. 14, 2022, the entirety of which is incorporated by reference herein.

### BACKGROUND

In an eyewear display, display light beams from a light engine are initially coupled into a waveguide by an incoupler which can be formed on a surface, or multiple surfaces, of the waveguide or disposed within the waveguide. Once the display light beams have been coupled into the waveguide, the incoupled display light beams are “guided” through the waveguide, typically by multiple instances of total internal reflection (TIR), to then be directed out of the waveguide by an outcoupler, which can also be formed on or within the waveguide. The outcoupled display light beams overlap at an eye relief distance from the waveguide forming an exit pupil within which a virtual image generated by the light engine can be viewed by the user of the eyewear display. The waveguide can also include an exit pupil expander positioned between the incoupler and the outcoupler to increase the size of the exit pupil within which the user can view the virtual image.

In some cases, one or more of the incoupler, exit pupil expander, and the outcoupler are implemented in the waveguide as a set of reflective facets. Conventional waveguides with reflective facets are often susceptible to diminished optical performance due to discontinuities in the virtual image delivered to the user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display in accordance with some embodiments.

FIG. 2 shows an example of a projection system with a light filter arranged between the light engine and an incoupler of a waveguide of an eyewear display, such as that shown in FIG. 1, in accordance with some embodiments.

FIG. 3 shows a plan view illustrating an example of the propagation of light within the waveguide of the projection system of FIG. 2, in accordance with some embodiments.

FIG. 4 shows an example of a conventional reflective facet configuration and problems associated with such a configuration.

FIGS. 5-8 show implementations of a dual reflective facet configuration at an outcoupler of a waveguide, in accordance with some embodiments.

FIG. 9 shows two graphs illustrating an improvement in the display uniformity of outcoupled light of the dual reflective facet configuration of the present disclosure compared to a conventional reflective facet configuration, in accordance with some embodiments.

FIG. 10 shows a flowchart describing a method for outcoupling light via an outcoupler with a dual reflective facet set configuration, in accordance with some embodiments.

### DETAILED DESCRIPTION

A reflective facet waveguide includes one or more sets of reflective facets to implement one or more of the incoupler, outcoupler, or exit pupil expander. Utilizing an outcoupler as an example, the outcoupler is realized as a set of reflective facets that receives light from the exit pupil expander and reflects the light out of the waveguide to the user. Typically, the set of reflective facets is made by applying a reflective coating to a series of planar faces on a molded plastic or polymer substrate. Ideally, each reflective facet has sharp corners at both edges and there is no gap between adjacent reflective facets. However, in reality, conventional molded plastic substrates have planar faces with rounded edges as well as draft angles (i.e., non-perpendicular angles) between the planar faces due to molding process limitations. These rounded edges and draft angles result in gaps between adjacent conventional reflective facets that are applied to the planar faces. The gaps between adjacent conventional reflective facets generate gaps in the outcoupled light, which in turn produce discontinuities in the virtual image delivered to the user. For example, if the virtual image is supposed to be a straight line, the gaps in the outcoupled light produce “blips” in the line that is perceived by the user. Described herein are techniques that provide a waveguide with a dual reflective facet configuration configured to receive light from two directions and reflect the received light toward a common direction. In this manner, the light reflected from a first set of reflective facets in the dual reflective facet configuration fills in the gaps of the light reflected from a second set of reflective facets in the dual reflective facet configuration. This reduces or eliminates discontinuities in the light that is outcoupled by the waveguide, thereby improving the optical performance of the waveguide and of the eyewear display.

To illustrate, in some embodiments, a waveguide includes an incoupler, an exit pupil expander, and an outcoupler. At least one of these waveguide components, such as the outcoupler, includes a dual reflective facet configuration. The dual reflective facet configuration receives light from two directions and redirects the light toward a common direction (e.g., an outcoupling direction). For example, the dual reflective facet configuration includes a first set of reflective facets arranged to reflect light from one of the two directions and a second set of reflective facets to reflect light from the other of the two directions. The reflective facets of the two sets are arranged in alternating manner such that a reflective facet of the first set is followed by a reflective facet of the second set, which is followed by a reflective facet of the first set, and so on. In this manner, the gaps in the light reflected from the first set of reflective facets are filled in by the light reflected by the second set of reflective facets. Additionally, in some embodiments, the reflective facets of the first set are configured to reflect light having a first optical characteristic (e.g., a first wavelength range, a first polarization state, or a first angle of incidence) and transmit light having a second optical characteristic (e.g., a second wavelength range, a second polarization state, or a second angle of incidence), while the reflective facets of the second set are configured to reflect light having the second optical characteristic and transmit light having the first optical characteristic. In this manner, the reflective facet configuration described herein reduces or eliminates gaps in the light that is outcoupled from the waveguide, thereby improving the quality of the image perceived by the user.

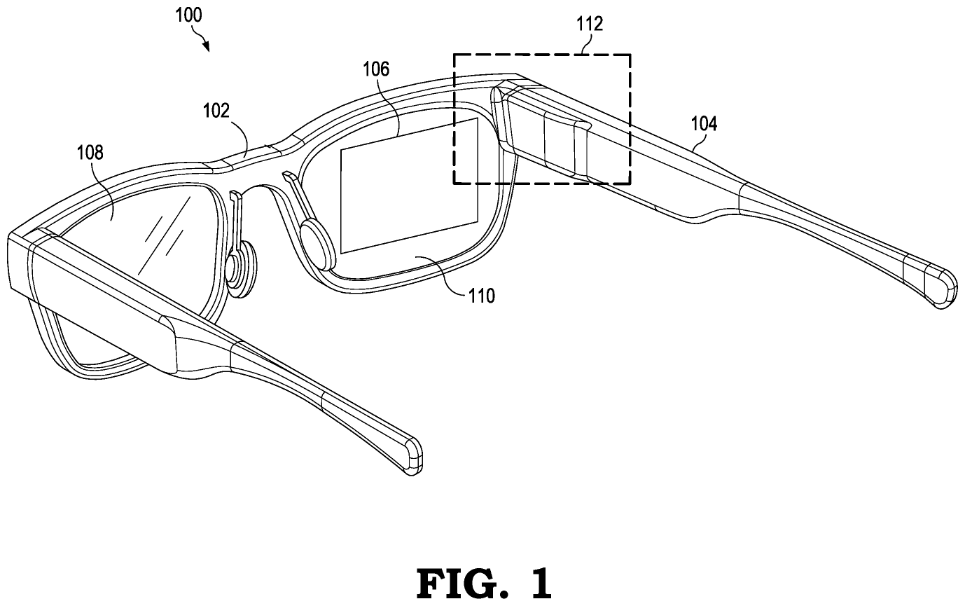

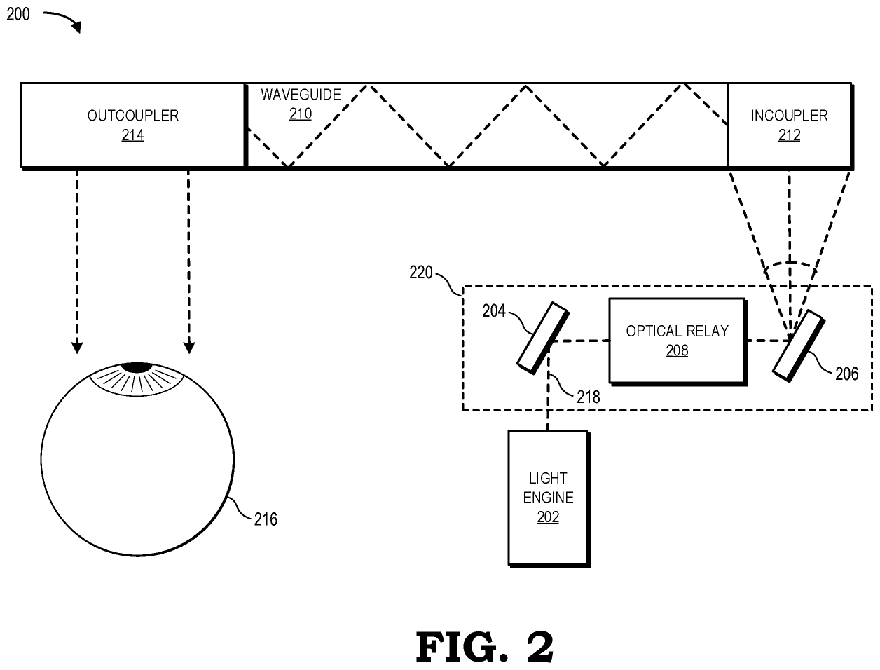

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as a light engine and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102 or within a nose bridge region of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an augmented reality (AR) or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from a light engine in the eyewear display 100. For example, light used to form a perceptible image or series of images may be projected by the light engine of the eyewear display 100 onto the eye of the user via a series of optical elements, such as a waveguide formed at least partially in the corresponding lens element, one or more scan mirrors, one or more optical relays, and/or one or more prisms. One or both of the lens elements 108, 110 thus includes at least a portion of a waveguide that routes display light received by the incoupler of the waveguide to an outcoupler of the waveguide, which outputs the display light toward an eye of a user of the eyewear display 100. The display light is modulated and projected onto the eye of the user such that the user perceives the display light as an image in FOV area 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the light engine is a matrix-based projector, a scanning laser projector, or any combination of a modulative light source such as a laser or one or more LEDs and a dynamic reflector mechanism such as one or more dynamic scanners or digital light processors. In some embodiments, the light engine includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The light engine is communicatively coupled to a controller and a non-transitory processor-readable storage medium or memory storing processor-executable instructions and other data that, when executed by the controller, cause the controller to control the operation of the projector. In some embodiments, the controller controls a scan area size and scan area location for the light engine and is communicatively coupled to a processor (not shown) that generates content to be displayed at the eyewear display 100. The light engine scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the eyewear display 100.

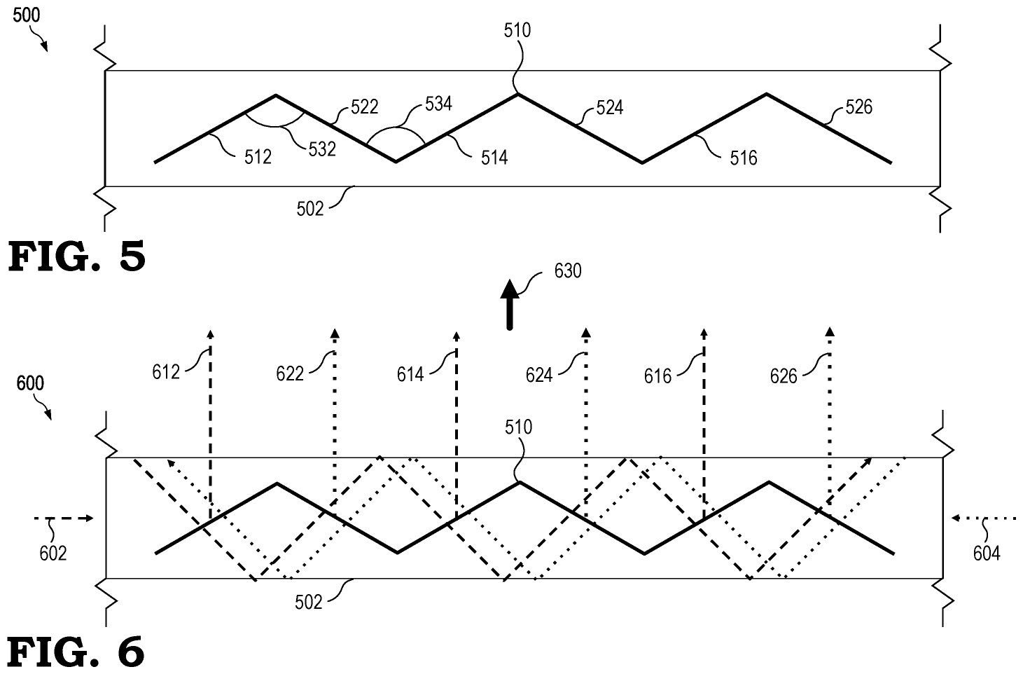

As previously mentioned, a waveguide is integrated into one or both of lens elements 108, 110. In some configurations, the waveguide includes a single waveguide substrate and in other configurations, the waveguide includes multiple waveguide substrates stacked on top of one another (referred to as a waveguide stack). The waveguide, in some cases, includes one or more of an incoupler to incouple light from the light engine into the waveguide, an exit pupil expander to expand the incoupled light within the waveguide in one dimension, and an outcoupler to outcouple the display light to the eyebox of the eyewear display 100. In some cases, one or more of the incoupler, the exit pupil expander, and the outcoupler include a dual reflective facet configuration (e.g., such as the dual reflective facet configuration shown in FIGS. 5-8). This minimizes or eliminates gaps in the light that is outcoupled via FOA area 106, thereby improving the optical performance of the eyewear display 100.

FIG. 2 illustrates a diagram of a projection system 200 that projects images onto the eye 216 of a user in accordance with various embodiments. The projection system 200, which may be implemented in the eyewear display 100 in FIG. 1, includes one or more of a light engine 202, an optical scanner 220, and/or a waveguide 210. In this example, the optical scanner 220 includes a first scan mirror 204, a second scan mirror 206, and an optical relay 208. The waveguide 210 includes one or more incouplers 212 and one or more outcouplers 214, with the one or more outcouplers 214 being optically aligned with an eye 216 of a user. For example, the one or more outcouplers 214 substantially overlaps with the FOV area 106 shown in FIG. 1.

The light engine 202 includes one or more light sources configured to generate and output light 218 (e.g., visible light such as red, blue, and green laser light and/or non-visible laser light such as infrared laser light). In some embodiments, the light engine 202 is coupled to a controller or driver (not shown), which controls the timing of emission of light from the light sources of the light engine 202 (e.g., in accordance with instructions received by the controller or driver from a computer processor coupled thereto) to modulate the light 218 to be perceived as images when output to the retina of the eye 216 of the user. For example, during operation of the projection system 200, one or more beams of display light 218 are output by the light source(s) of the light engine 202 and then directed into the waveguide 210 before being directed to the eye 216 of the user. The light engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the optical scanner 220 includes a first scan mirror 204, a second scan mirror 206, and an optical relay 208. One or both of the scan mirrors 204 and 206 are MEMS mirrors, in some embodiments. For example, the scan mirror 204 and the scan mirror 206 are MEMS mirrors that are driven by respective actuation voltages to oscillate during active operation of the laser projection system 200, causing the scan mirrors 204 and 206 to scan the laser light 218. Oscillation of the scan mirror 204 causes light 218 output by the optical engine 202 to be scanned through the optical relay 208 and across a surface of the second scan mirror 206. The second scan mirror 206 scans the light 218 received from the scan mirror 204 toward an incoupler 212 of the waveguide 210.

The waveguide 210 of the projection system 200 includes an incoupler 212 and an outcoupler 214. The term “waveguide,” as used herein, will be understood to mean a combiner using total internal reflection (TIR), or via a combination of TIR, specialized filters, and/or reflective surfaces, to transfer light from an incoupler to an outcoupler. For display applications, the light is representative of a collimated image, for example, and the waveguide transfers and replicates the collimated image to the eye. In general, the terms “incoupler” and “outcoupler” will be understood to refer to any type of optical grating structure, including, but not limited to, a set of reflective facets, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, one or more of the incoupler 212, an exit pupil expander (not shown in FIG. 2), and the outcoupler 214 include a dual reflective facet configuration as described herein (e.g., as shown in FIGS. 5-8). In the present example, the light 218 received at the incoupler 212 is propagated to the outcoupler 214 via the waveguide 210 using TIR. The laser light 218 is then output to the eye 216 of a user via the outcoupler 214.

In some embodiments, the projection system 200 includes an additional light engine 202 (along with an additional optical scanner 220, both not shown) and the waveguide 210 includes an additional incoupler 212 (not shown) to incouple light into the waveguide 210 from the additional light engine 202. For example, one light engine 202 is positioned in the temple region of the eyewear display and the other light engine (now shown) is positioned in the nose bridge region of the eyewear display 100 shown in FIG. 1. Incoupler 212 incouples light from the light engine 202 in the temple region into the waveguide 210 toward the outcoupler 214 and the additional incoupler (not shown) incoupled light from the light engine in the nose bridge region into the waveguide 210 toward the outcoupler 214 from a different direction. In this manner, the outcoupler 214, which, in some embodiments, includes a dual reflective facet configuration, receives light from two different directions.

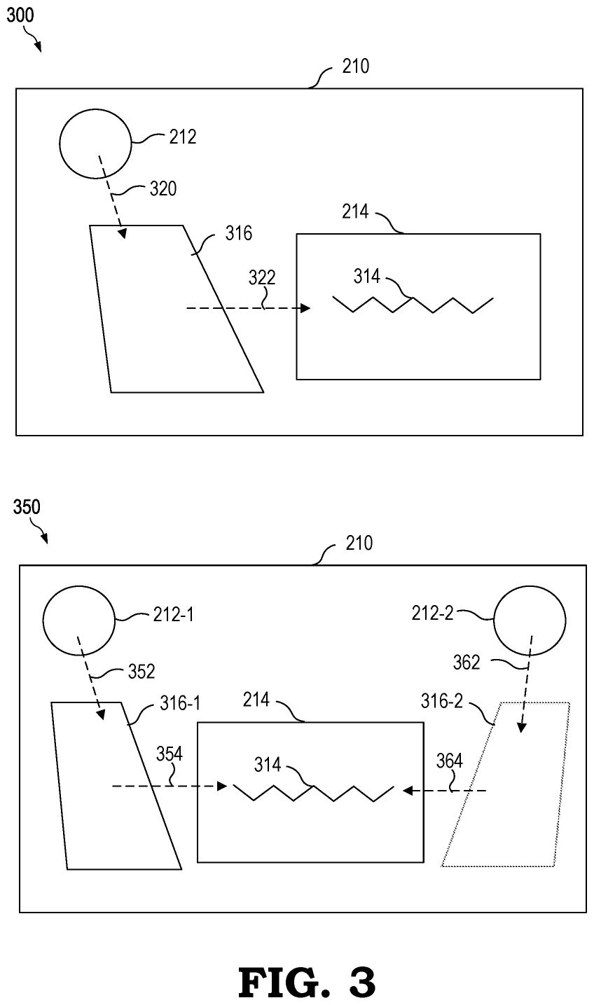

FIG. 3 shows a first plan view 300 of an example of light propagation within the waveguide 210 of the projection system 200 of FIG. 2. As shown, light is received via incoupler 212, directed as light 320 into an exit pupil expander (EPE) 316, and then propagated within the waveguide 210 as light 322 to the outcoupler 214 to be output from the waveguide 212 toward the eye of the user (e.g., the light is reflected by the outcoupler 214 in a direction out of the page). In some embodiments, the exit pupil expander 316 expands one or more dimensions of the eyebox of an eyewear display that includes the laser projection system 200 (e.g., with respect to what the dimensions of the eyebox of the eyewear display would be without the exit pupil expander 316). In some embodiments, at least one of the incoupler 212, the exit pupil expander 316, and the outcoupler 214 each include a dual reflective facet configuration. For example, the outcoupler 214 includes dual reflective facet configuration 314 that reflects the light 322 received from the exit pupil expander 316 such that the light is outcoupled of the waveguide 210, which in this illustration, corresponds to an outcoupling direction out of the page. This eliminates or reduces gaps in the light that is outcoupled by the outcoupler 214.

FIG. 3 also shows a second plan view 350 of an example of light propagation within the waveguide 210 of a projection system with a dual incoupler configuration. As shown, light is received via a first incoupler 212-1, directed as light 352 into a first EPE 316-1, and then propagated within the waveguide 210 as light 354 to the outcoupler 214 to be output from the waveguide 212 toward the eye of the user (e.g., the light is reflected by the outcoupler 214 in a direction out of the page). The waveguide 210 also includes a second incoupler 212-2 to incouple light into the waveguide 210. As shown, light is received via a second incoupler 212-2, directed as light 362 into a second EPE 316-2, and then propagated within the waveguide 210 as light 364 to the outcoupler 214 to be output from the waveguide 212 toward the eye of the user. In some embodiments, at least one of the incouplers 212, the exit pupil expanders 316, and the outcoupler 214 include a dual reflective facet configuration. For example, the outcoupler 214 includes dual reflective facet configuration 314 that reflects the light 354 received from the exit pupil expander 316-1 and the light 364 received from exit pupil expander 316-2 such that the light is outcoupled of the waveguide 210 in an outcoupling direction toward the user. This eliminates or reduces gaps in the light that is outcoupled by the outcoupler 214.

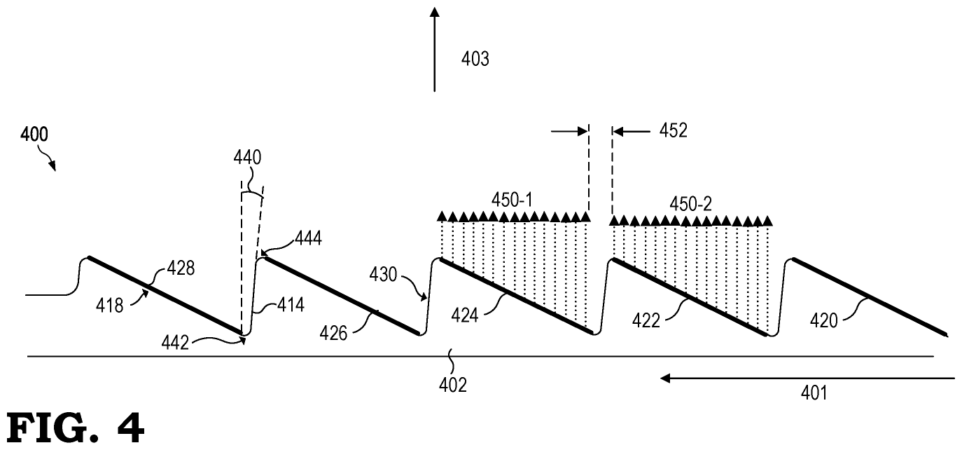

FIG. 4 shows a cross-section view 400 illustrating a set of conventional reflective facets 420-428 in a waveguide (not shown for clarity) and associated problems. When implemented in the waveguide as an outcoupler, for example, the set of conventional reflective facets 420-428 receives light from an exit pupil expander coming from a first direction indicated by arrow 401 and redirects the light out of the waveguide to the user in a second direction indicated by arrow 403.

Generally, the substrate 402 is manufactured by a molding process and is made of a plastic or polymer material that is at least partially transparent. The molded substrate 402 includes a plurality of planar faces 418 (one labeled for clarity). The molded substrate 402 also includes a plurality of secondary planar surfaces 430 (one labeled for clarity). The set of conventional reflective facets 420-428 is formed by applying a reflective coating to the plurality of planar faces 418. Ideally, the plurality of planar faces 418 of the substrate 402 have sharp corners and the secondary planar surfaces are vertical so that there are no gaps between adjacent ones of the reflective facets. In reality, the molded plastic substrates such as substrate 402 do not meet this ideal shape and instead include rounded tips 444 (one labeled for clarity) and rounded roots 442 (one labeled for clarity). In addition, the secondary planar surfaces 430 of molded plastic substrates such as substrate 402 are not vertical and impart draft angles 440 (one labeled for clarity) between the root 442 of one conventional reflective facet 428 and the tip 444 of an adjacent conventional reflective facet 426. The combination of the rounded edges (i.e., roots 442 and tips 442) and the draft angles 440 result in gaps between adjacent ones of the conventional reflective facets 420-428, which in turn create gaps in the light that is reflected by the set of conventional reflective facets 420-428. For example, referring to conventional reflective facets 422 and 424, there is a gap 452 between the light 450-1 reflected by conventional facet 424 and the light 450-2 reflected by conventional facet 422. These gaps 452 result in discontinuities in the virtual image that is delivered to the user, therefore resulting in diminished optical performance.

FIG. 5 shows a cross section view 500 of a portion of a waveguide 502 with a dual reflective facet configuration 510 in accordance with some embodiments. In some aspects, the portion of the waveguide 502 corresponds to waveguide 210 of FIGS. 2 and 3, and the dual reflective facet configuration 510 is included in one or more of the incoupler, exit pupil expander, or the outcoupler of the waveguide. For purposes of this explanation, the dual reflective fact configuration 510 is described as being integrated at the outcoupler (e.g., outcoupler 214 of FIGS. 2 and 3). In other embodiments, another dual reflective fact configuration similar to dual reflective fact configuration 510 is additionally integrated into the incoupler and/or the exit pupil expander.

In some embodiments, the dual reflective facet configuration 510 is configured to receive light from two directions and redirect it in a common direction (e.g., an outcoupling direction). The dual reflective facet configuration 510 includes a first set of reflective facets 512, 514, 516 and a second set of reflective facets 522, 524, 526. In some embodiments, the first set of reflective facets 512, 514, 516 and the second set of reflective facets 522, 524, 526 are arranged in alternating manner so that each reflective facet in the first set 512, 514, 516 is adjacent to one or more reflective facets in the second set 522, 524, 526. In some embodiments, the first set of reflective facets 512, 514, 516 is arranged to receive light from a first direction of the two directions and direct it in the common direction and the second set of reflective facets 522, 524, 526 is arranged to receive light from a second direction of the two directions and direct it in the same common direction as the first set of reflective facets 512, 514, 516. In some embodiments, the reflective facets in the first set of reflective facets 512, 514, 516 are parallel or substantially parallel to one another and the reflective facets in the second set of reflective facets 522, 524, 526 are parallel or substantially parallel to one another.

In some embodiments, the second set of reflective facets 522, 524, 526 reflect light in the mirror image compared to the first set of reflective facets 512, 514, 516. In some embodiments, the dual reflective facet configuration 510 is designed such that each set of reflective facets has sufficient angular selectivity to reflect or transmit light as required. For example, in some embodiments, the top angles 532 (only one labeled for clarity), the bottom angles 534 (only one labeled for clarity), and/or the materials selected for each set of the two sets of reflective facets provide sufficient angular selectivity to reflect or transmit light as required. In some embodiments, each of the reflective facets in the first set of reflective facets 512, 514, 516 are angularly positioned and include materials to reflect light of a first optical characteristic, such as a first wavelength range (e.g., corresponding to a particular color of light), a first polarization state (e.g., s-polarized light), or a first angle of incidence, and transmit light of a second optical characteristic, such as a second wavelength range (e.g., corresponding to a different color of light), a second polarization state (e.g., p-polarized light), or a second angle of incidence. For example, the first set of reflective facets 512, 514, 516 are dichroic mirror layers or polarization beam splitter layers. Similarly, in some embodiments, each of the reflective facets in the second set of reflective facets 522, 524, 526 are angularly positioned and include materials to reflect light of the second optical characteristic, such as the second wavelength range or the second polarization state, and transmit light of the first optical characteristic, such as the first wavelength range or the first polarization state. For example, the second set of reflective facets 522, 524, 526 are dichroic mirror layers or polarization beam splitter layers.

The dual reflective facet configuration 510 of FIG. 5 shows an embodiment with three reflective facets in each of the first and second sets of reflective facets. In other embodiments, other numbers of reflective facets are included in each set.

FIG. 6 shows a cross section view 600 of the propagation of light through the portion of the waveguide 502 with the dual reflective facet configuration 510 of FIG. 5 in accordance with some embodiments. The dual reflective facet configuration receives light from a first direction 602 (e.g., from a first exit pupil expander in the waveguide, such as from exit pupil expander 316-1 as shown in the second plan view 350 of FIG. 3) and receives light from a second direction 604 (e.g., from a second exit pupil expander in the waveguide, such as from exit pupil expander 316-2 as shown in the second plan view 350 of FIG. 3). In some embodiments, the light received from the first direction 602 has a first optical characteristic (e.g., a first wavelength range, a first polarization state, or a first angle of incidence) and the light received from the second direction 604 has a second optical characteristic (e.g., a second wavelength range, a second polarization state, or a second angle of incidence).

The first set of reflective facets (not labeled in FIG. 6 for clarity) reflect the light received from the first direction 602 in an outcoupling direction 630. That is, a first reflective facet in the first set of reflective facets (reflective facet 512 of FIG. 5) reflects the light as light 612, a second reflective facet in the first set of reflective facets (reflective facet 514 of FIG. 5) reflects the light as light 614, and a third reflective facet in the first set of reflective facets (reflective facet 516 of FIG. 5) reflects the light as light 616. The second set of reflective facets (not labeled in FIG. 6 for clarity) reflect the light received from the second direction 604 in the outcoupling direction 630. That is, a first reflective facet in the second set of reflective facets (reflective facet 526 of FIG. 5) reflects the light as light 626, a second reflective facet in the second set of reflective facets (reflective facet 524 of FIG. 5) reflects the light as light 624, and a third reflective facet in the second set of reflective facets (reflective facet 522 of FIG. 5) reflects the light as light 622.

FIG. 7 shows another cross section view 700 of the portion of the waveguide 502 with the dual reflective facet configuration 510 of FIGS. 5 and 6 focusing on the outcoupled light 702. As illustrated, the outcoupled light 702 reflected from the dual reflective facet configuration 510 includes little or no gaps in light. In this manner, the dual reflective facet configuration 510 reduces or eliminates gaps in the outcoupled light 702 as compared to the conventional reflective facet configuration shown in FIG. 4. Thus, a waveguide with an outcoupler having a dual reflective facet configuration as described herein is able to improve the quality of the image delivered to the user.

FIG. 8 shows a cross section view 800 of the portion of a waveguide 802 with a dual reflective facet configuration 810 (e.g., corresponding to the one shown in FIG. 8) in accordance with various embodiments. In some embodiments, dual reflective facet configuration 810 is similar to dual reflective facet configuration 510 shown in the previous figures. In this embodiment, the light that is received from the two directions originates from direction 830 (e.g., from a single exit pupil expander 316 as shown in the first plan view 300 of FIG. 3). For example, the light from direction 830 includes light having a first optical characteristic (e.g., a first polarization state). A first portion of the light from direction 830 is reflected by a first set of reflective facets 812, 814, 816 in the dual reflective facet configuration 810 as light 832, 834, 836, respectively. After passing through the dual reflective facet configuration 810, the remaining light that is not reflected by the first set of reflective facets 812, 814, 816 reflects off of a reflective surface 804 and is redirected back toward the dual reflective facet configuration 810 as the light coming from a second direction 838. In some embodiments, in addition to reflecting the light, the reflective surface 804 converts the light from the first optical characteristic to the second optical characteristic (e.g., from a first polarization state to a second polarization state, or at a different angle). In this manner, the light that is reflected off of reflective surface 804 is propagated back through the waveguide 802 and the dual reflective facet configuration 810 and reflects off of the second set of reflective facets 826, 824, 822 of the dual reflective facet configuration 810 as reflected light 840, 842, 844, respectively.

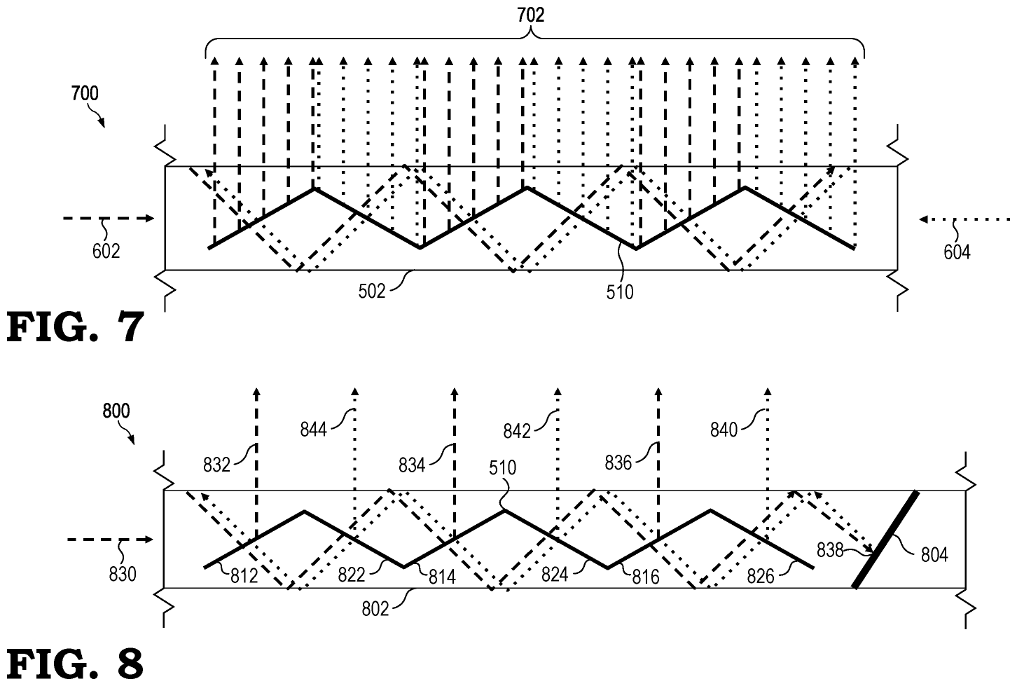

FIG. 9 shows a first graph 900 with a line 910 illustrating how the uniformity of outcoupled light (indicated on the y-axis) decreases as a function of the position on the OC (indicated on the x-axis) according to conventional methods in which reflective facets receive light from a single direction. FIG. 9 also shows a second graph illustrating how the techniques described herein increase the overall uniformity of outcoupled light (indicated by light 964) by implementing a dual reflective facet configuration that receives light from two directions, where line 960 corresponds to the uniformity of outcoupled light of light received from a first direction and line 962 corresponds to the uniformity of outcoupled light of light received from a second direction. The overall uniformity of light shown by line 964 in graph 950 is much more uniform across the position of the outcoupler as compared to receiving light from a single direction as shown in graph 900.

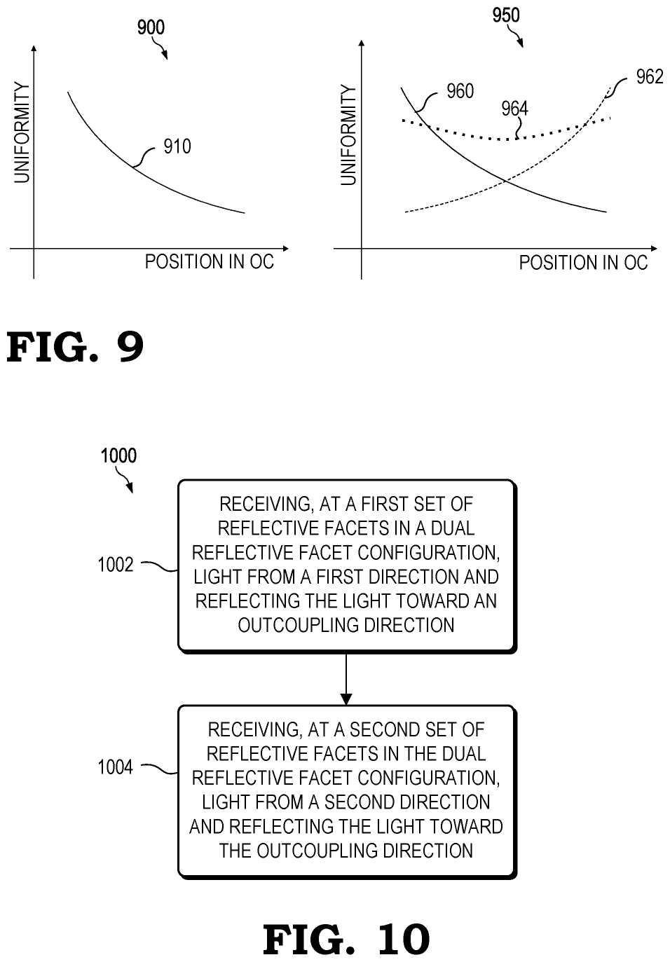

FIG. 10 shows a method flowchart 1000 for outcoupling light via an outcoupler with a dual reflective facet configuration, such as those described with respect to FIGS. 5-9, in accordance with some embodiments. At 1002, the method includes receiving, at a first set of reflective facets in a dual reflective facet configuration, light from a first direction and reflecting the light toward an outcoupling direction. At 1004, the method includes receiving, at a second set of reflective facets in the dual reflective facet configuration, light from a second direction and reflecting the light toward the outcoupling direction.

In some embodiments, the techniques provided herein eliminate the gaps between reflective facets as seen in conventional reflective facet waveguides. As such, the techniques described herein provide a waveguide with reflective facets that deliver a more uniform and higher quality virtual image to the user of an eyewear display such as that shown in FIG. 1. In addition, the dual reflective facet configuration disclosed herein utilizes more surfaces as reflective facets for imaging purposes than convention configurations. Accordingly, the need for steep angles that are needed for the non-imaging facets in the conventional reflective facet configuration (e.g., as shown in FIG. 4) is obviated, thus making it easier to fabricate the dual reflective facet configuration as compared to the conventional reflective facet configuration.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
an outcoupler with a dual reflective facet configuration comprising:
a first set of reflective facets to receive light from a first direction and reflect light incident thereon to an outcoupling direction, and
a second set of reflective facets to receive light from a second direction and reflect light incident thereon to the outcoupling direction.

2. The waveguide of claim 1, wherein reflective facets of the first set of reflective facets alternate with reflective facets of the second set of reflective facets in the dual reflective facet configuration.

3. The waveguide of claim 2, wherein reflective facets of the first set of reflective facets are parallel to one another, wherein reflective facets of the second set of reflective facets are parallel to one another and not parallel to reflective facets of the first set of reflective facets.

4. The waveguide of claim 1, wherein the reflective facets of the first set of reflective facets transmits light from the second direction.

5. The waveguide of claim 4, wherein the reflective facets of the second set of reflective facets transmits light from the first direction.

6. The waveguide of claim 1, wherein light from the first direction has a first optical characteristic, and light from the second direction has a second optical characteristic.

7. The waveguide of claim 6, wherein the first optical characteristic is a first polarization state and the second optical characteristic is a second polarization state different from the first polarization state.

8. The waveguide of claim 1, wherein light from the first direction is received from a first light engine and light from the second direction is received from a second light engine.

9. The waveguide of claim 1, further comprising a reflective surface positioned adjacent to the dual reflective facet configuration, wherein the reflective surface is configured to receive light from the first direction and reflect it back toward the dual reflective facet configuration as the light from the second direction.

10. A method to outcouple light of a waveguide, the method comprising:
receiving, at a first set of reflective facets in a dual reflective facet configuration, light from a first direction and reflecting the light toward an outcoupling direction; and
receiving, at a second set of reflective facets in the dual reflective facet configuration, light from a second direction and reflecting the light toward the outcoupling direction.
